(19) United States
(12) Patent Application Publication
(10) Pub. No.: US 2007/0300306 A1
(43) Pub. Date: Dec. 27, 2007

(54) METHOD AND SYSTEM FOR PROVIDING GRANULAR DATA ACCESS CONTROL FOR SERVER-CLIENT APPLICATIONS

(76) Inventor: Basit Hussain, Tampa, FL (US)

Correspondence Address: Cerebit Security Application, Inc;Suite 266, 14499 N. Dale Mabry Highway, Tampa, FL, 33618, US

(21) Appl. No.: 11/425,524

(22) Filed: Jun. 21, 2006

(51) Int. Cl. H04L 9/32

(52) U.S. Cl. 726/27

(57) ABSTRACT

A system (400) for managing access to data served by an application operating in server-client configuration employs an interceptor (340) interposed between a data server (323) and a coupled client (321). The interceptor (340) determines client access privileges based on configured authentication and data access privilege information. The interceptor (340) operates to intercept and modify information packets sent in response client requests to the server according to data redaction rules or procedures that identify data fields and restricted portions of such data fields.

### CROSS-REFERENCE TO RELATED APPLICATIONS

This application is related to U.S. patent application Ser. No. 10/905,481 filed Jan. 6, 2005, entitled “Enterprise Security and Auditing Method and Apparatus”, and owned by Cerebit Security Applications, Inc, which application is incorporated herein by reference in its entirety.

### FIELD OF THE INVENTION

This invention relates in general to server-client applications, and more particularly, to systems for selectively restricting client access to data provided by server applications.

### BACKGROUND OF THE INVENTION

Securing access to enterprise resources is a balancing act between usability and control. It requires vigilance, persistence, care, and effort. The process starts with risk and vulnerability assessment of the enterprise's assets followed by the security policy definition. When business needs require dispensing data to the Internet and sharing information with partner networks, a unique set of security challenges that cannot be solved by the traditional solutions of firewalls and virtual private networks is presented. In addition to other characteristics, enterprise security policies determine what resources must be available, to whom, and under what circumstances. Policy determination is followed by developing security architecture to implement the defined policy. The architecture is implemented with strategically placed infrastructure components such as firewalls, authentication tools, and intrusion detection systems. Security policy is also implemented in part by access control mechanisms, regular security audits, predefined incident response procedures, and security awareness programs. These implementations are designed to reduce the overall security risk of the organization. It is not possible to render an enterprise completely risk free, as a residual risk always remains. However, by proper selection and implementation of the correct security procedures and prioritizing the assets protection can minimize such residual risk.

Current access control in a corporation typically utilizes a centralized authentication system. There are several problems with existing implementations known in the art. Even though the authentication is centralized, authorization, and therefore, access control is still distributed. Access control lists are usually kept at the application or the server running the application making it exponentially difficult to implement and monitor security policy as the number of applications grows. Additionally, after the authentication has taken place, the security of transactions depends on the applications. Usually most applications were not designed with security in mind. Such transactions are usually open to man-in-the middle, data corruption, replay and repudiation attacks. Most systems known in the art rely on password authentication. Passwords are well known to be the weakest form of authentication. In addition, these systems are usually not flexible to allow multiple types of credentials (e.g. certificates, hardware tokens, or biometrics) and cannot change the privileges assigned to the users based on type of credentials that were presented. Due to the design of prior art systems it is rather cumbersome to implement a new security policy since many access control lists have to be modified manually. As such, the security policy cannot be modified dynamically and it is impossible to implement a more complex context based security policy involving more than one application.

There are some prior-art efforts that claim to provide application security, however these efforts fail to address all the security needs in a comprehensive manner. Prior art systems address logging and security in different contexts, do not comprehensively address authentication and authorization, and do not include support for incident response. These efforts usually require significant changes to the existing applications. Since organizations have made heavy investments into those applications, they end up neglecting security due to the huge investment required and the fear of disruption of ongoing operations.

In many prior-art systems, access control is insufficiently granular to allow selective access to data in an easily configurable manner. For example, it is typical that a user is granted access privilege at an application level, or at a transaction level. The access privilege allows the user to gain access to a substantial amount of information, some of which may be unnecessary for normal job function. Moreover, it is often difficult to further refine the user access to particularized data without a substantial investment in reconfiguring of an application. This is a particularly true for legacy systems not initially designed with such access control in mind. When many different types of applications are involved, the problem is further exacerbated.

It is desirable to have a cost effective, easily configurable system that enables granular access control to data served by one or more applications. Prior art access controls generally do not provide sufficient granularity without having to make a substantial investment in modifying or managing such applications. Accordingly, a new data access control methodology and system is needed.

### BRIEF DESCRIPTION OF THE DRAWINGS

FIG. 1 shows an abstract representation of a prior art enterprise network infrastructure having a server-client application and standard access control mechanisms;

FIG. 2 is a representative diagram showing an enterprise system configured with an interceptor based authentication and data access control mechanism, in accordance with the present invention;

FIG. 3 shows a representative diagram highlighting the authentication process for authorizing client access to the application servers, in accordance with the present invention;

FIG. 4 shows a representative diagram highlighting an interceptor based data redaction system for controlling client access to data served by an application server, in accordance with the present invention;

FIG. 5 shows a flowchart of procedures used in the system of FIG. 4;

FIG. 6 shows an example of data redaction in a forms based application, in accordance with the present invention.

### SUMMARY OF THE INVENTION

A system having application server and client has an access control server that provides granular data access control. In one aspect of the invention, an interceptor acting independent of the server and client determines access privilege for the client to particularized data served by the application server, intercepts an information packet transmitted from the application server in response to a data retrieval request from the client, identifies the particularized data within the information packet, and reconfigures a portion of the information packet to selectively block access to the particularized data based on the access privilege of the client, before transmitting the reconfigured information packet to the client.

In a second aspect of the invention, an access control server operating independently from the client and application server, intercepts an information packet transmitted from the application server in response to a data retrieval request from the client, and redacts a portion of the information packet to selectively block access to the particularized data based on access privilege of the client to the particularized data, before transmitting the reconfigured information packet to the client.

### DETAILED DESCRIPTION OF THE PREFERRED EMBODIMENT

Generally, the present invention provides for a system for managing access to data served by an application operating in server-client configuration. The system employs an interceptor module interposed between a data server and a coupled client that determines client access privileges based on a database or server that provides authentication and data access privilege information. The interceptor module operates to intercept and modify responses sent from the server to the client according to data redaction rules or procedures that identify data fields and restricted portions of such data fields. In one embodiment, the response is modified to mask portions of a restricted access data field with substitute characters indicating that masking has occurred while retaining the format integrity of the response. In the preferred embodiment, the interceptor module operates independently from the server and client, and is configurable to support multiple protocols, and multiple levels of data hiding.

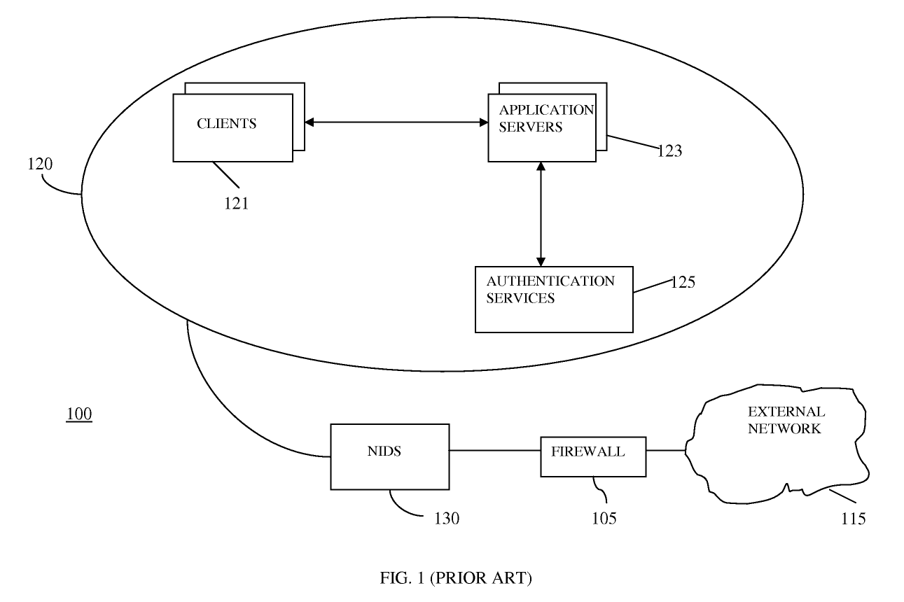

FIG. 1 shows an abstract representation of a prior art enterprise network infrastructure 100 that is considered well protected according to current security standards. The enterprise network infrastructure 100 comprises an internal network 120 of application servers 123 and clients 121. The internal network 120 interfaces with an external network 115, such as the Internet, through one or more firewalls 105. The firewalls generally provide for a first line of defense for the internal network 120 by blocking undesired access to data and services within the internal network. Depending on the partitioning of the network and corporate security policy, there could be a number of firewalls between the external network 115, and the internal network 120. Within the internal network 120, clients 121 interface with application servers 123 for providing access to databases and for providing other services. A network intrusion detection system (NIDS) 130 monitors the traffic and records suspicious patterns. The NIDS 130 may raise alarms if a monitored parameter crosses a threshold. The enterprise network infrastructure 100 has a central authentication server 125 that provides authentication service for client users. Many applications in the enterprise may use this authentication service. Some applications may require the users to provide more authentication credentials directly to them. Each application or server on the enterprise has its own access control list that maps authenticated users to privileges. A significant problem in this prior art system results from the distribution of the access control lists. Since each application maintains its own access control list, implementation of changes in corporate policy are difficult and laborious. Additionally, granular application and data access control are generally not available, unless specifically supported by a particular application. In fact, most applications only support rudimentary features in this regard and many provide none.

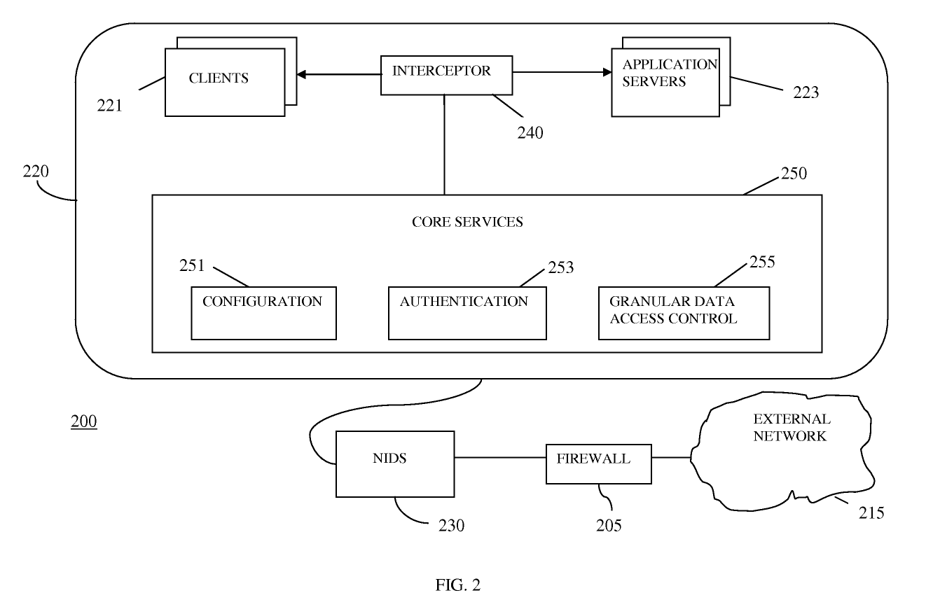

FIG. 2 is a representative diagram showing an enterprise system 200 configured with a novel authentication and data access control mechanism, in accordance with the present invention. As in traditional systems, the enterprise system 200 has an internal network 220 having application servers 223, and clients 221 for interfacing with the application servers 223 to provide access to data and services. Similarly, the system 200 has a NIDS 230 and a firewall 205 for providing a defense against unauthorized intrusions from a connected external network 215, such as the Internet. However, according to the present invention, the system 200 further includes an interceptor 240 and a set of core services 250 that include modules 251, 253, 255 for providing configuration, authentication and granular data access control services 253, 255. The configuration module 251 supports system administration functions including the definition and maintenance of application and data access privileges and data redaction rules and procedures. The interceptor 240 is implemented as an independent module (such as a hardware module configured with appropriate software) physically located on the network in the access path between the application server 223 and client 221. In this manner, the interceptor 240 functions as a gateway to the application server 223. The functions of the interceptor 240 are described in more detail below.

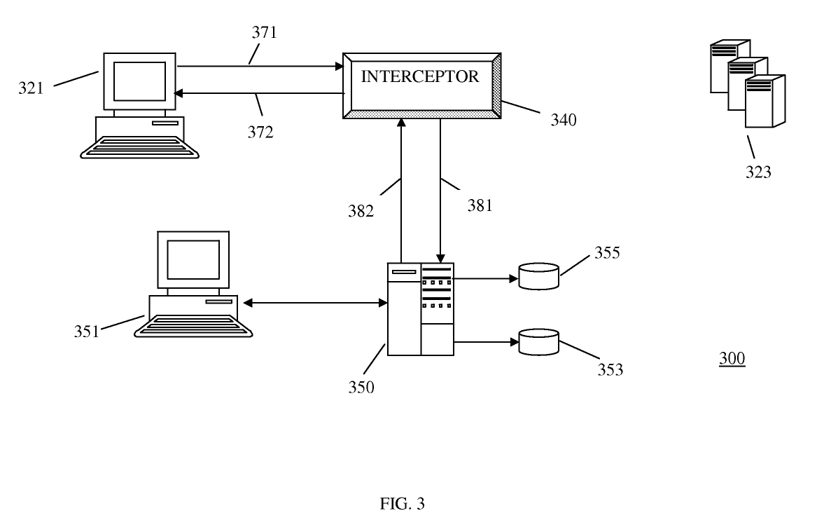

FIG. 3 shows a representative system 300 highlighting the authentication process for authorizing client access to the application servers, in accordance with the present invention. A client 321 initiates an authentication request 371 targeted at an application server 323 by providing his or her credentials. Credentials are usually a user name and password or a digital certificate. However, other forms of authentication may be used. In a significant departure from typical prior art systems, the authentication request is intercepted by the interceptor, and this request is forwarded by the interceptor to the core services server. The submitted credentials are submitted in a verification request 381 to a server 350 for checking against stored credentials in an authentication database 353. If the credentials are successfully verified, the server 350 also retrieves from a database 355 access privilege or policies 382 for the client to particularized data served by the application server. A success or failure code is returned in a response to the client, depending on the success of the verification process. In the preferred embodiment, the interceptor creates a session for the client user and associates the governing policies associated with the client user. The interceptor returns a unique session identifier 372 to the user which is used in all subsequent requests during the session. All such requests are subject to the privileges defined in these policies.

After authentication and the establishment of a session, the client user submits requests for data to the application servers, which in turn respond to the client user with the corresponding data in a predetermined data format. Depending on the application, authentication enables the client to access data grouped in broad classifications. For instance, an application may grant the client access to certain reports or pages containing predefined data fields. However, for some instances a finer granularity of data access control is required. Accordingly, the present invention provides for a redaction methodology for restricting access to specific data fields or to specific portions of a data field to permit a higher granularity of data access control. This methodology is particularly useful for legacy applications, where application modification is undesirable, impractical or too costly.

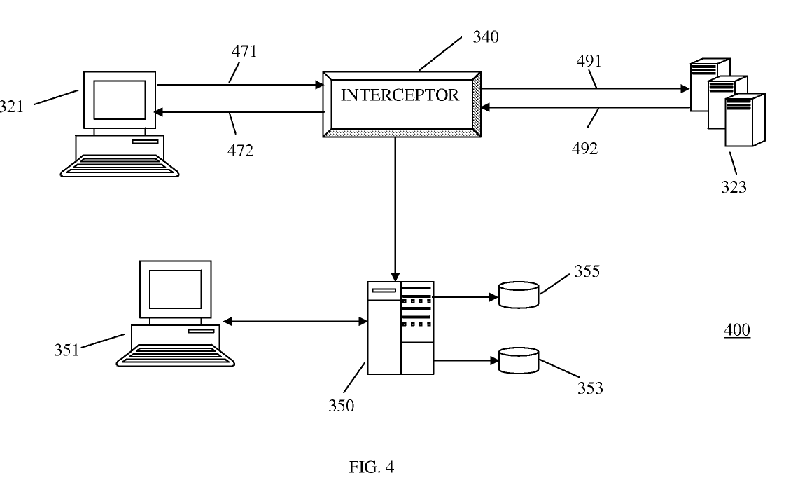

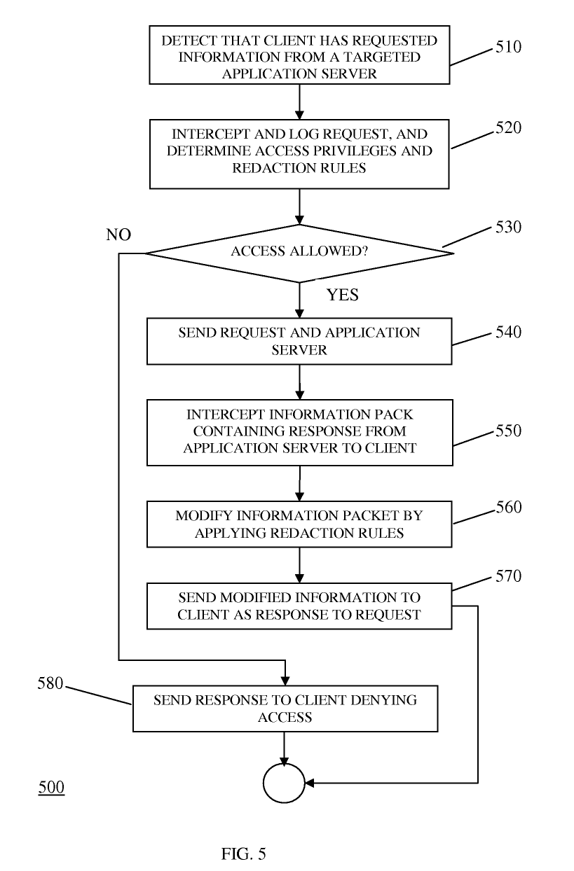

FIG. 4 shows a representative diagram of a system 400 having a process for selectively restricting client access to data at the data field level, in accordance with the present invention. FIG. 5 shows a flowchart of procedures used in the process. Once a user session is created successfully, the client 321 submits an information request 471 targeted at one of the application servers. The interceptor 340 detects that the client has requested information from a targeted application server, step 510. The interceptor intercepts and logs this request, and determines access privileges and data redaction rules, step 520. The request is logged in the audit database for forensic purposes, regardless of whether access is allowed or not. If access is allowed for the type of role possessed by this client, the request is allowed to propagate, i.e., a corresponding request 491 is forwarded to the application server, steps 530, 540. The application server processes the request and sends a response 492 with an information packet corresponding to the request. The interceptor intercepts this response, step 550, and according to the invention, modifies the information packet to redact information from the information packet, thereby restricting client access to selected data fields or to selected portions of a data field, step 560. Preferably, redaction is performed according to a set of redaction rules retrieved from a database, based in part on the identity or type of the client. The redaction rule includes protocol deconstruction rules, and rules for identifying particularized data within the information packet. The interceptor operates to reconfigure or modify a portion of the information packet to selectively block access to the particularized data based on the access privilege of the client. Modifications are made by substituting masking data for at least a portion of the information packet or by removing portions of the information packet while maintaining format integrity for the information packet. In one embodiment, the protocol deconstruction rules are used to identify particular data fields, and reconfiguration is done by removing or substituting for part but not all of a data field. The interceptor then transmits the modified response 472 to the client, step 570.

In the preferred embodiment, the interceptor selects from among multiple protocols interpretation or parsing and redaction rules configured in a database and associated with a particular client, based on the access privilege of the client. The rules include procedures, algorithms, and pattern matching for identifying protocols, and for parsing or separating data fields, and for identifying data fields for rescission or redaction. Information requests are generally formatted according to an application communications protocol. Some protocols are defined very rigidly while the others are defined in a looser fashion. The redaction process involves interpreting these protocols and extracting the patterns that identify the critical information. Identification of these patterns may involve studying the information requests and identifying the delimiters that enclose the critical information.

In the preferred embodiment, redaction rules or procedures are established by first configuring the system in a log-only mode. This setup does not require any authentication or policy definition. Information flows through the interceptor and gets logged in an audit database. The logged information is examined to assess the information patterns and how sensitive or restricted information is delimited within the requests. The patterns are used to define the redaction rules. The rules are mapped to the different roles defined by business needs to complete the redaction configuration process.

Preferably, the interceptor loads redaction rules at startup time. Once the rules are loaded, the interceptor scans incoming requests to identify data fields or particularized data, such as by identifying specific delimiters. In one embodiment, restricted information within the delimiters (data fields) are masked, by replacing the data with blanks, spaces, or other characters.

In one supported protocol, HTTP, the HTTP requests are scanned to remove specific columns of information. In this case, the redaction rules are defined as a repetitive pattern that executes on each row of the table. In the supported TDS, protocol, redaction is based on the SQL server and Sybase, such as available from the Microsoft or Sybase companies. Similar to the case of HTTP, the interceptor removes a specific column of information from the results of a query. In the supported LDAP protocol, responses are returned as binary or text information in the form of a tree structure. LDAP redaction works on the nodes of the tree and essentially prunes some of the branches to return only partial records. In the supported XML redaction, specific elements of a document are removed leaving the rest of the document untouched. These modifications are made while ensuring that document integrity and formed is maintained. Middleware redaction is also contemplated where information from requests submitted through middleware protocols such as RMI, .NET, IIOP and J2EE is removed. Significantly, the interceptor supports partial redaction. For partial redaction, portions of the response such as portions of a specific data field are modified to mask critical information to an extent that it is not useful to anyone trying to utilize it for unintended purposes, while allowing client users to continue to use the remainder of response.

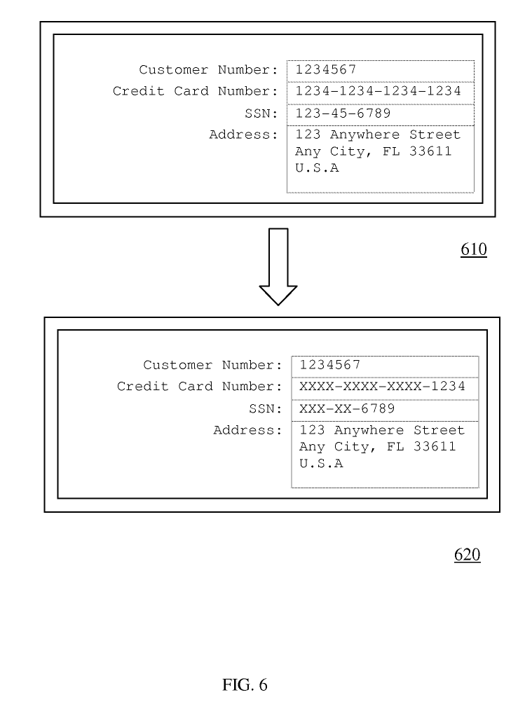

FIG. 6 shows one example in which sensitive information is modified by the interceptor, in accordance with the present invention. In a first screen 610, shown without redaction, sensitive data in a form data field, such as credit card information and social security information, are visible to a client user. In a second screen 620, redaction is applied to hide restricted information, by modify a portion but not all of the form data field. Here, the first several digits or characters of a credit card number are redacted such that only the last four digits remain readable. This is accomplished by replacing the characters to be hidden with spaces, asterisks, or other non-informational data. In other embodiments, the interceptor is also configured to redact other personal or otherwise sensitive data in a similar manner. Significantly, the action of the interceptor results in a modified version of the original response, and it is this modified response that is returned to the user that requested it, the user seeing only a part of the original information sent back. Note that for a user having the proper access privileges, the form data fields referenced above are not modified, leaving the data fields visible to the user in their entirety.

The present invention provides for a significant advance over the prior art. The interceptor is preferably implemented as an independent server interposed between an application server and client. In one embodiment, the application server and client are tightly coupled, and the interceptor works by deconstructing the protocol used between application server and client to identify and redact information unauthorized for client access. This arrangement allows for access control, and data hiding (also referred to as redaction) to be implement for legacy applications without modification to the application server or client. A single interceptor may be configurable to support multiple types of protocols and multiple application server client relationships, all controlled from rules centralized in a database, and centrally administered. Alternatively, interceptors may be protocol dependent, i.e., interceptors are configured to handle specific protocols and distributed to support various server client applications.

What is claimed is:

1. In a system having an application server and client having an established server-client relationship there between, a method of data access control comprising the steps of:
at an access control server operating independently from the client and application server:
determining access privilege for the client to particularized data served by the application server;
intercepting an information packet transmitted from the application server in response to a data retrieval request from the client;
identifying the particularized data within the information packet;
modifying a portion of the information packet to selectively block access to the particularized data based on the access privilege of the client; and
transmitting the reconfigured information packet to the client.

2. The method of claim 1, wherein the step of modifying comprises the step of substituting masking data for at least a portion of the particularized data.

3. The method of claim 1, wherein the step of modifying comprises the step of removing the particularized data from the information packet while maintaining format integrity for the information packet.

4. The method of claim 1, wherein the information packet contains a data field having personal information and the step of modifying comprises the step of redacting a portion but not all of the data field.

5. The method of claim 1, wherein the step of intercepting comprises the step of selecting from among a plurality of protocol interpretation rules.

6. The method of claim 5, wherein the step of intercepting comprises the step of selecting a parsing procedure dependent on a data protocol.

7. The method of claim 1, wherein the information packet contains sensitive information, such as a credit card number, and the step of reconfiguring comprises the step of redacting all or only a portion of the credit card number or sensitive information.

8. The method of claim 1, wherein the information packet contains personal identification information and the step of reconfiguring comprises the step of redacting at least a portion of the personal identification information.

9. In a system having an application server and client, a method of data access control comprising the steps of:
at the client,
submitting an authentication request including client credentials for establishing a server-client relationship with the application server; and
submitting a data retrieval request to the application server;
at the application server,
transmitting an information packet in response to the data retrieval request;
at an access control server operating independently from the client and application server:
intercepting the authentication request from the client;
verifying the client credentials against an authentication database;
establishing a session for the client upon verifying the client credentials;
determining access privilege for the client to the data based on the client credentials;
intercepting the information packet transmitted from the application server in response to the data retrieval request;
reconfiguring the information packet to selectively block access to a subset of data within the information packet based on the access privilege of the client to the subset of data; and
transmitting the reconfigured information packet to the client.

10. The method of claim 9, wherein the step of reconfiguring comprises the step of substituting masking data for the subset of data.

11. The method of claim 9, wherein the step of reconfiguring comprises the step of removing the subset of data from the information packet while maintaining format integrity for the information packet.

12. In a system having an application server and client having an established server-client relationship there between, a method of data access control comprising the steps of:
at an access control server operating independently from the client and application server:
intercepting an information packet transmitted from the application server in response to a data retrieval request from the client;
redacting a portion of the information packet to selectively block access to the particularized data based on access privilege of the client to the particularized data; and
transmitting the reconfigured information packet to the client.

13. The method of claim 12, wherein the step of redacting, comprises the steps of:
extracting a particular data field according to a protocol deconstruction rule customized for responses from the application;
reconstructing the particular data field to mask a portion of data therein; and
inserting masking characters to visual indicate to a client user that a portion of the particular data field has been redacted.

14. The method of claim 12, further comprising, at the access control server, the steps of:
presenting a set of data fields corresponding to a particular application;
receiving identification of access privilege for a client user;
receiving identification of at least one data field for redaction corresponding to the access privilege for the client user;
storing a redaction rule for controlling access to the at least one data field when requested by the client user.

15. A data access control system comprising:
an application server;
a client for providing a data presentation interface;
a network coupling the application server to the client;
an access control server interposed on the network between the application server and the client;
wherein the access control server operates to determine client access privilege based on a request from the client to the application server, and operates to intercept an information packet sent from the application server in response to the request from client and redact a portion of the information packet not permitted for client access based on the client access privilege.

16. The data access control system of claim 15, wherein the access control server comprises a configuration database that maps access privileges to portions of data fields.

17. A system for managing access to data served by an application operating in server-client configuration, comprising:
a client having client data access privilege defined therefor; and
a data server coupled to the client, and responsive to requests from the client to send an information packet thereto; and
an interceptor interposed between the data server and client, the interceptor configured to intercept and modify information packets sent in response to requests from the client to the server according to data redaction procedures that identify data fields and restricted portions of such data fields based on the client data access privilege information.

18. The system of claim 17, wherein the access control server comprises a module separate and independent from the data server and client.
